(19) United States
(12) Patent Application Publication
(10) Pub. No.: US 2015/0323422 A1
(43) Pub. Date: Nov. 12, 2015

(54) SYSTEM AND METHOD FOR EVALUATING OPPORTUNITIES TO EXTEND OPERATING DURATIONS

(71) Applicant: General Electric Company, Schenectady, NY (US)

(72) Inventors: Rajesh Sarda, Bangalore (IN); Joseph Vincent Pawlowski, Laguna Hills, CA (US); Sudip Sinha, Bangalore (IN)

(73) Assignee: General Electric Company, Schenectady, NY (US)

(21) Appl. No.: 14/274,920

(22) Filed: May 12, 2014

(51) Int. Cl. G01M 15/14; G01M 99/00

(52) U.S. Cl. CPC G01M 15/14; G01M 99/005

(57) ABSTRACT

Aspects of the present disclosure relate generally to a system and method for evaluating opportunities to extend operating durations. A system according to the present disclosure can include: a computing device in communication with a machine amongst a plurality of machines within a machine system, the machine being subject to a particular operating duration, wherein the computing device is configured to perform actions including: examining operating data for the machine; modeling future performance data for the machine; calculating an operating duration extension risk for the machine; determining whether the machine is eligible for an operating duration extension based on the examined operating data, the modeled future performance data, and the calculated operating duration extension risk; and calculating an extension readiness metric for the machine in response to the machine being eligible for the operating duration extension.

### CROSSREFERENCE TO RELATED APPLICATIONS

The current application is related to co-owned and co-pending U.S. Patent Application No. 2013/0179356, filed on Jul. 11, 2013, and entitled “Method and System for Maintenance of Turbomachinery.”

### BACKGROUND OF THE INVENTION

The subject matter disclosed herein relates to machine systems made up of several discrete, interconnected machines. More specifically, the present disclosure relates to a system and method for evaluating opportunities to extend the operating duration of one or more machines within a machine system.

Machine systems may include multiple components in the form of individual machines. In one example, a machine system may be a turbomachine system which includes turbines, compressors, pumps, etc. As a machine system operates, the overall characteristics of the system (e.g., efficiency and performance) may change over time. The change in these characteristics may be due to a variety of factors such as stresses, strains, and wear. To maintain the machine system, various machines within the machine system may be subject to respective “operating durations,” between which a particular machine is disabled in “a maintenance outage” for inspections, repairs, and/or replacements. Maintenance outages may be time-consuming and costly when scheduled too frequently.

### BRIEF DESCRIPTION OF THE INVENTION

At least one embodiment of the present disclosure is described herein with reference to evaluating opportunities to extend the operating duration of one or more machines within a machine system. However, it should be apparent to those skilled in the art and guided by the teachings herein that embodiments of the present invention are generally applicable to other, related technical situations.

A first aspect of the present disclosure provides a system. The system can include a computing device in communication with a machine amongst a plurality of machines within a machine system, the machine being subject to a particular operating duration, wherein the computing device is configured to perform actions including: examining operating data for the machine; modeling future performance data for the machine; calculating an operating duration extension risk for the machine; determining whether the machine is eligible for an operating duration extension based on the examined operating data, the modeled future performance data, and the calculated operating duration extension risk; and calculating an extension readiness metric for the machine in response to the machine being eligible for the operating duration extension.

A second aspect of the present disclosure provides a method implemented with a computing device. The method can include: examining operating data for a machine amongst a plurality of machines within a machine system with a determinator component of the computing device, the machine being subject to a particular operating duration; modeling the future performance data for the machine with a calculator component of the computing device; calculating an operating duration extension risk for the operating duration with the calculator component of the computing device; determining whether the machine is eligible for an operating duration extension based on the examined operating data with the determinator component of the computing device, the modeled future performance data, and the calculated operating duration extension risk; and calculating an operating extension readiness metric for the machine with the calculator component of the computing device in response to the machine being eligible for the operating duration extension.

A third aspect of the present disclosure provides a program product stored on a computer readable storage medium for evaluating operating extension opportunities. The computer readable storage medium can include program code for causing a computer system to: examine operating data for a machine, the machine being subject to an operating duration, wherein the machine comprises one of a plurality of machines within a machine system; model future performance data for the machine; calculate an operating duration extension risk for the operating duration; determine whether the machine is eligible for an operating duration extension based on the examined operating data, the modeled future performance data, and the calculated operating duration extension risk; and calculate an operating extension readiness metric for the machine in response to the machine being eligible for the operating duration extension.

### BRIEF DESCRIPTION OF THE DRAWING

These and other features of the disclosed apparatuses will be more readily understood from the following detailed description of the various aspects of the apparatus taken in conjunction with the accompanying drawings that depict various embodiments of the invention, in which:

FIG. 1 is a schematic view of a turbomachine assembly.

FIG. 2 is an illustrative environment which includes a computer system interacting with a machine system database and a machine according to an embodiment of the present disclosure.

FIG. 3 illustrates an example data flow between a machine and a computer system in an embodiment of the present disclosure.

FIGS. 4 and 5 each depict an illustrative flow diagram of methods according to an embodiment of the present disclosure.

It is noted that the drawings are not necessarily to scale. The drawings are intended to depict only typical aspects of the disclosure, and therefore should not be considered as limiting its scope. In the drawings, like numbering represents like elements between the drawings.

### DETAILED DESCRIPTION OF THE INVENTION

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be used and that changes may be made without departing from the scope of the present teachings. The following description is, therefore, merely exemplary.

Embodiments of the present disclosure include a system, method, and program product for evaluating whether one or more machines in a machine system are eligible for an extended operating duration. As described herein, a “machine system” can include an interdependent cluster of discrete machines, equipment, assemblies, systems, subassemblies, subsystems, etc., each of which can be referred to individually as a “machine.” In one example, some machines within a machine system can include turbines (e.g., gas turbines and/or steam turbines), supplementary turbine systems, and/or subassemblies thereof.

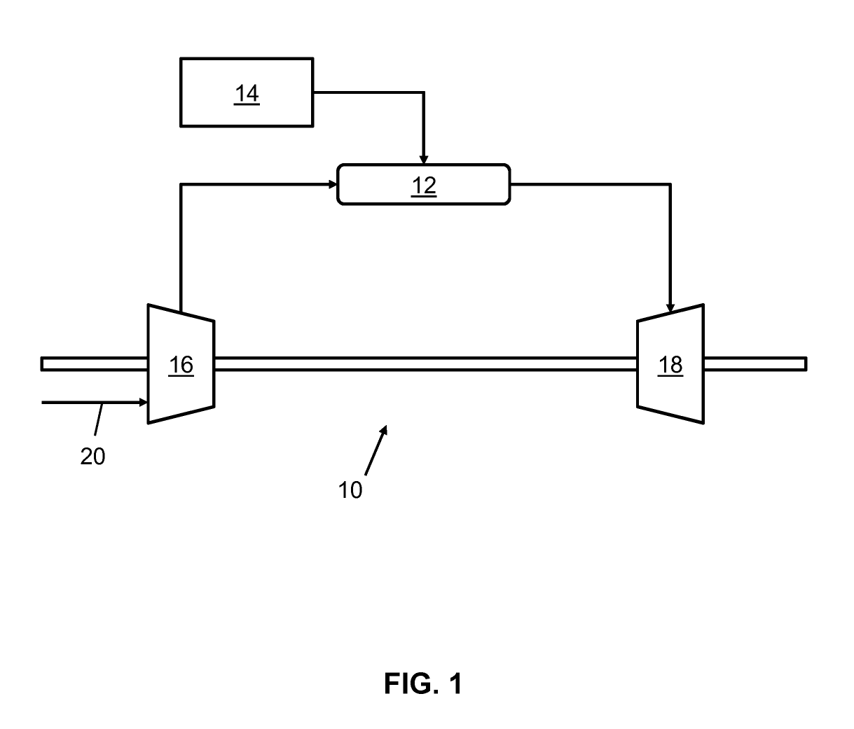

FIG. 1 shows a schematic view of a gas turbine assembly 10 included as an example of a turbomachine. A combustor 12, connected to a fuel nozzle 14, is typically located between the compressor 16 and turbine 18 sections of gas turbine assembly 10. Air 20 flows sequentially through compressor 16, combustor 12, and lastly through turbine 18. Combustor 12, fuel nozzle 14, compressor 16, and/or turbine 18 can be known as “parts” of gas turbine assembly 10. Each of the parts discussed herein can be repaired or replaced as necessary after gas turbine assembly 10 operates for a particular length of time. Each of the parts discussed herein may also include several subassemblies and subparts. In addition, gas turbine assembly 10 may be one of several machines within a larger machine system. Although gas turbine assembly 10 is described herein for the purposes of example and demonstration, it is understood that the present disclosure can be adapted in different embodiments for use with other types of machines, such as steam turbine assemblies, internal combustion engines, etc.

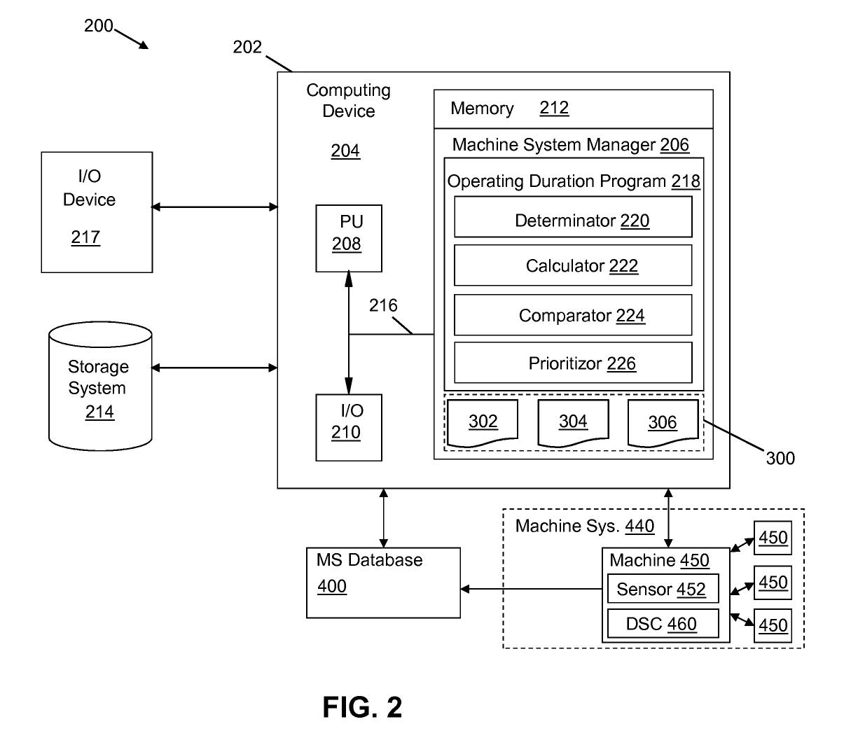

Turning to FIG. 2, an illustrative environment 200 for performing the various processes described herein is shown. In particular, a computer system 202 of environment 200 can include a computing device 204, which in turn can include a machine system manager 206. Machine system manager 206 can enable computing device 204 to analyze various types of data pertaining to machines within a machine system according to embodiments of the disclosure.

The components shown in FIG. 2 are one embodiment of a system for evaluating opportunities to extend the operating duration of machines within a machine system. As discussed herein, computing device 204 can provide information to a human or computerized user to indicate whether particular machines are eligible for an operating duration extension and/or quantify this eligibility as an “operating extension readiness metric.” Embodiments of the present disclosure may be operated manually by a technician, automatically by computing device 204, and/or by a combination of a technician and computing device 204. It is understood that some of the various components shown in FIG. 2 can be implemented independently, combined, and/or stored in memory for one or more separate computing devices that are included in computing device 204. Further, it is understood that some of the components and/or functionality may not be implemented, or additional schemas and/or functionality may be included as part of machine system manager 206.

Computing device 204 can include a processor unit (PU) 208, an input/output (I/O) interface 210, a memory 212, and a bus 216. Further, computing device 204 is shown in communication with an external I/O device 217 and a storage system 214. Memory 212 can include various software components configured to perform different actions, including a determinator 220, a calculator 222, a comparator 224, and/or a prioritizor 226. One or more of determinator 220, calculator 222, comparator 224, and/or prioritizor 226 can use algorithm-based calculations, look up tables, and similar tools stored in memory 212 for processing, analyzing, and operating on data to perform their respective functions. In general, PU 208 can execute computer program code to run software, such as variable clearance system 204, which can be stored in memory 212 and/or storage system 214. While executing computer program code, PU 208 can read and/or write data to or from memory 212, storage system 214, and/or I/O interface 210. Bus 216 can provide a communications link between each of the components in computing device 204. I/O device 217 can comprise any device that enables a user to interact with computing device 204 or any device that enables computing device 204 to communicate with the equipment described herein and/or other computing devices. I/O device 217 (including but not limited to keyboards, displays, pointing devices, etc.) can be coupled to computer system 202 either directly or through intervening I/O controllers (not shown).

Memory 212 can also include various forms of data 300 pertaining to one or more machines and/or machine systems. For example, operating data 302 can include any data for describing the design, past performance, present performance, and other types of currently available information based on the known operation of a particular machine. Future performance data 304 can include any variables related to estimates, predictions, etc. regarding a particular machine's future performance characteristics within and beyond its current operating duration. Interval extension risk data 306 can include any metrics derived from operating data 302 and/or future performance data 304 for predicting a particular machine's future condition, including probability-based metrics. Particular examples of data 300 and their use in embodiments of the present disclosure are described in detail elsewhere herein.

In some embodiments, as shown in FIG. 2, computing device 204 may interact with a machine system (MS) database 400 for storing past and present data for one or more machines within the same machine system, and can include predictive technical and/or economic models for each machine and/or the machine system as a whole. In addition or alternatively, computing device 204 can exchange data with a machine system 440 which includes one or more machines 450 therein (e.g., assemblies of steam turbine 10 (FIG. 1)). Further, machines 450 of machine system 440 can exchange data with machine system database 400. One or more machines 450 can also include a sensor 452 for detecting operational data, conditions, characteristics, etc. which can be provided to computing device 204 and/or machine system database 400.

Sensors 452 can include position sensors, temperature sensors, pressure sensors, pressure taps, material quality sensors, and/or any other types of instrumentation currently known or later developed. Sensors 452 can be any type of equipment for measuring or determining variables (e.g. pressures, temperatures, forces, stresses, strains, and/or other measurable changes in condition) for one or more machines 450. Sensors 452 therefore can obtain various types of data which can be provided to computer system 202, a data storage component (DSC) 460 of machine 450 and/or machine system database 400 by any currently known or later developed type of data coupling, including I/O device 217. This data 300, once in memory 212, can be processed with machine system manager 206 to determine whether a particular machine 450 is eligible for an operating duration extension.

In an embodiment, computer system 202 can evaluate whether machines 450 within machine system 440 are eligible for an operating interval extension based on their previous operating conditions, current operating conditions, predicted future performance data, and any associated risks (e.g., within operating data 302, future performance data 304, and/or interval extension risk data 306). Modules within operating duration program 218 can illustrate this eligibility into a mathematical quantity such as an “operating extension readiness metric” in some embodiments of the present disclosure. Further information on data used in embodiments of the present disclosure is provided elsewhere herein.

Computing device 204 can comprise any general purpose computing article of manufacture for executing computer program code installed by a user (e.g., a personal computer, server, handheld device, etc.). However, it is understood that computing device 204 is only representative of various possible equivalent computing devices and/or technicians that may perform the various process steps of the disclosure. In addition, computing device 204 can be part of a larger architecture for managing machine system 440.

To this extent, in other embodiments, computing device 204 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. In one embodiment, computing device 204 may include a program product stored on a computer readable storage device, which can be operative to evaluate operating extension opportunities when executed.

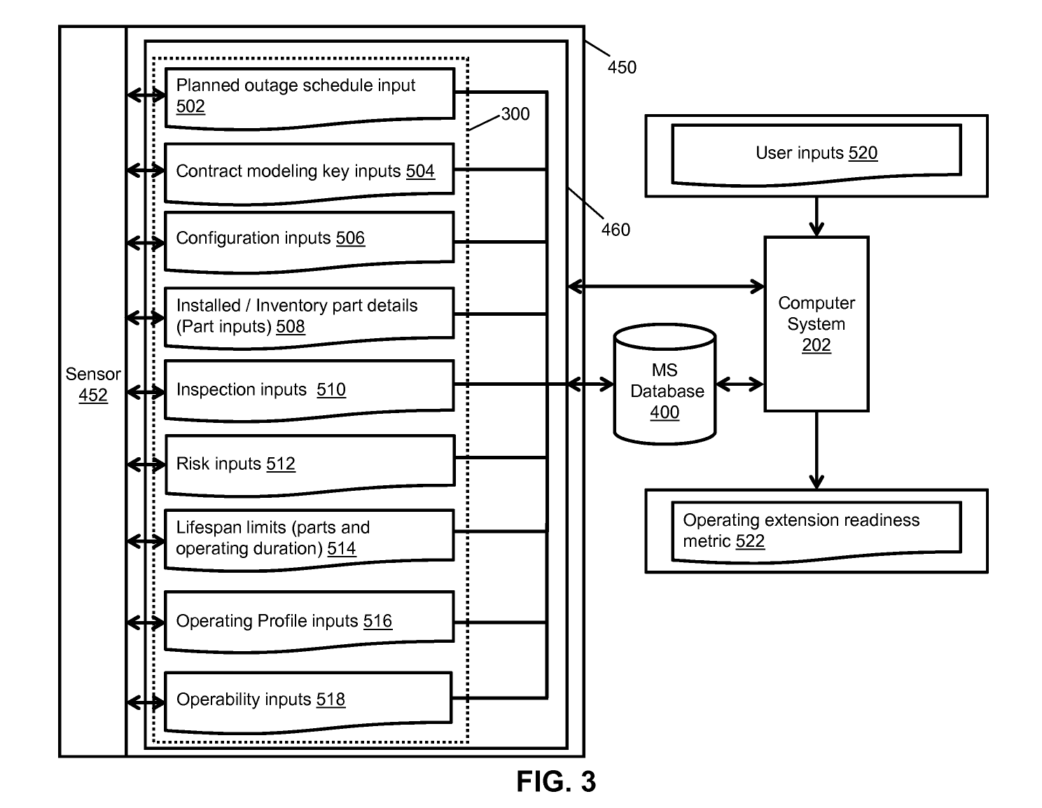

Turning to FIG. 3, an example data flow between machine 450, machine system database 400, and computer system 202 is shown. As described elsewhere herein, machine 450 and/or machine system database 400 can provide several types of data 300 (FIG. 2) to computer system 202 to evaluate opportunities for extending the operating duration of one or more machines 450. Machine 450 can include data storage component 460 with several types of data 300, examples of which are shown in FIG. 3 and discussed herein. Data storage component 460 can obtain data by derivation from other data or inputs from computer system 202 and/or machine system database 400, in addition to sensor(s) 452 of machine 450. It is understood that other conceivable forms of data may be provided and used in embodiments of the present disclosure. Further, process steps by which the various forms of data 300 can be used are described in detail elsewhere herein.

In the example of a turbine system, each machine 450 can be in the form of, e.g., a compressor component, a combustion component, or a hot gas path (HGP) component. Compressor components can include, e.g., blades and vanes of different stages, and theoretically have few restrictions on their replacement life (i.e., no planned operating duration). However, reports from inspections such as boroscope inspections can suggest repairs and maintenance for compressor components from unanticipated factors such as blade damage. Combustion components generally relate to combustion features of a gas turbine assembly and can include, e.g., a fuel nozzle, end cover, liner, liner cap, and/or transition piece. Combustion components generally have a particular operating duration and corresponding outage schedule. In different machine systems 440, combustion components can be arranged in a variety of different configurations and can be identified with different names. Hot gas path (HGP) components can include buckets, nozzles, and shrouds in various stages of machine system 440 relating to the flow of operating fluid through a gas turbine. Hot gas path components can also have particular operating durations and corresponding outage schedules.

Each machine 450 may be subject to a “planned outage schedule,” which generally refers to a scheduled time or times at which machine 450 or parts thereof can be inspected, repaired, and/or replaced. In the case of inspections, three example types of outages which can be scheduled for machine system 440 include inspection of combustion parts, inspection of combustion and hot gas path components (e.g., in a gas turbine), and/or major outages (e.g., complete end-to-end inspection of a turbine system including rotor, combustion, and hot gas path components). The planned outage schedule for machine 450 can be represented in data 300 as a planned outage schedule input 502. Planned outage schedule input 502 may represent, e.g., an initial prediction or recommended time for inspecting, repairing and/or replacing machine 450 based on accumulated data and/or engineering models. Planned outage schedule input 502 may represent the initial schedule for inspecting, repairing, and/or replacing machine 450, which can be modified in systems and methods described herein. As planned outage schedule input 502 includes a set time until the next outage, this information can be included with operating data 302 (FIG. 2).

Machine 450 can also include a set of “contract modeling key inputs” 504. Technical characteristics of machine 450 can include, e.g., the intended term and purpose of use, which can be stored in a “contract” data field for machine 450. Contract modeling key inputs 504 can include, for example, actual or intended uses (temperatures, hot gas path properties relative to combustion, speeds, use time, events, etc.) of machine 450, a fixed end of the operating duration, a forecasted outage/inspection schedule, a modeled operating duration, and/or a predetermined restriction. In addition, contract modeling key inputs can include technical limits (e.g., maximum tolerable variance in conditions or uses) based on information in the “contract” data field for machine 450. Contract modeling key inputs 504 can include several types of data relevant to current and future properties of machine 450, and therefore can be used as operating data 302 and/or future performance data 304.

Configuration inputs 506 can include past and predicted future technical data pertaining to the technical configuration of machine 450. Configuration inputs 506 may include technical data for each machine 450 such as combustion type, compressor type, fuel type and/or heating, use or absence of steam/water injections, control curve type (e.g., wet or dry), etc. Thus, configuration inputs 506 correspond to the technical characteristics of machine 450, rather than actual or intended uses. Unit configuration inputs 506 can also be used as either operating data 302 and/or future performance data 304, depending on the type of data collected and/or any processing in algorithms, models, etc. for calculating predictive data.

Data 300 can also include installed/inventory part details (part inputs) 508. Part inputs 508 can describe particular parts, subassemblies, expansions, etc., within machine 450 that may affect the overall performance of machine 450. For example, part inputs 508 may analyze a particular part (e.g., a liner, transition piece, cap, end cover, fuel nozzle, bucket, nozzle, etc.) which may age faster or slower than the overall condition of machine 450. Part inputs 508 generally can be a type of operating data 302, and in some cases may affect future performance data 304. Operating duration program 218 can also identify a lifespan-limiting part of machine 450 and/or describe the condition of the lifespan-limiting part by using part inputs 508. A “lifespan-limiting part” can include, e.g., parts which effectively limit the lifespan of machine 450 or cause machine 450 to fail when the part itself has failed. For example, comparator 224 can compare the remaining effective life or condition of a part with engineering limits to determine which of the parts within machine 450 are limiting its operating duration. For even more details related to parts of machine 450, part inputs 508 can include part inventory details and availability. Part inputs 508 can additionally include estimated delivery timelines for replacement parts in order to describe the effect of parts maintenance and replacements on an outage for machine 450.

Data 300 can also include reports and data obtained from inspections in the form of inspection inputs 510. Inspection inputs 510 can be obtained from any currently known or later developed inspection process, e.g., the most recent enhanced boroscope inspection (EBI) report. Inspection inputs 510 can provide operating data 302 for use in embodiments of the present disclosure. Inspection reports may show that some parts have broken or become damaged. Embodiments of the present disclosure can include computer system 202 obtaining a recommendation or guideline (e.g., by computation, lookup table, etc.) the obtained guidelines may include determining that no action is needed, or that a particular type of damage can be addressed in the next outage of machine 450. The recommendations and reports can be encoded as inspection inputs 510.

Embodiments of the present disclosure can also include obtaining (or calculating) risk inputs 512 from machine 450 which may be stored as interval extension risk data 306. Risk inputs 512 can include data 300 obtained directly from machine 450 or derived from other, related quantities. For example, embodiments of the present disclosure can include processes for measuring sources of degradation and/or failure within machine 450, and predicting whether these sources will cause machine 450 to fail. In addition, embodiments of the present disclosure can analyze and predict whether a failure of machine 450 will cause the entire machine system 440 or a portion thereof to fail. Risk inputs 512 can therefore include, e.g., variables for a particular risk model, risk of failure for specific parts, risk of unplanned outages, operability-related (i.e., operating time-related) risks, and overall risk metrics for machine 450 derived from several risk inputs 512. The risk of failure can be translated into a percentage, e.g., a likelihood of a failure occurring if machine 450 continues to operate after its operating duration elapses.

Embodiments of the present disclosure can also use predetermined lifespan limits 514 for individual parts and the operating duration of machine 450 to evaluate whether the operating interval of machine 450 can be extended. Individual parts within machine 450 can be subject to a maximum lifespan before being inspected, repaired and/or replaced, and this maximum lifespan can be set or predicted before installation (e.g., set by the manufacturer). Machine 450 may also be subject to a maximum operating duration independent from the operating duration of a particular cycle. For example, machine 450 may be subject to a limit on how long its operating duration can be extended. As predetermined lifespan limits 514 can affect the eligibility of machine 450 for operating extensions, they can be encoded as data 300 (specifically, a type of future performance data 304) and used for evaluating machine 450.

Data 300 can also include operating profile inputs 516. Generally, an “operating profile” of machine 450 refers to a total operating time or number of cycles over the lifetime of machine 450. Operating profile inputs 516 can be organized into days, weeks, months, etc. and thus can be organized in any desired manner. Operating profile inputs 516 can also include other data related to the total operating time for machine 450, such as the total time or the number of duty cycles since the last outage for machine 450. Other operating characteristics, such as whether machine 450 includes cyclic, continuous duty, or peaker operating types can be incorporated into operating profile inputs 516. Since machine 450 may have operated for a longer or shorter length of time than anticipated, operating profile inputs 516 can be used as operating data 302 in embodiments of the present disclosure.

Embodiments of the present disclosure can also include operability inputs 518 for describing the current technical effectiveness of machine 450. Operability inputs 518 can include, for example, the relative load taken on by machine 450 as compared to other machines within the same machine system 440. Redistribution of loads over time can increase or decrease the rate at which particular machines 450 degrade. Operability inputs 518 can illustrate the relative performance demand on each machine 450 within machine system 440 and therefore can be a type of operating data 302 used in systems and methods of the present disclosure.

The example inputs discussed herein can be stored as data 300 within data storage component 460 of machine 450. Computer system 202 can obtain data 300 directly from machine 450, or from machine system database 400 which can be in communication with one or more machines 450. Computer system 450 can be configured to perform methods according to the present disclosure based on information in data 300. For particular types of functionality, computer system 202 can accept user inputs 520 from a human or machine user (not shown). User inputs 520 can include user-specified restrictions or requests for evaluating opportunities to extend operating durations, including but not limited to projected operating durations, user override commands for particular recommendations, maintenance schedules for one or more machines 450, responses to outputs from computer system 202, one or more previous “mini outages” for replacing damaged parts, recommendations for performing inspections or changing parts, etc.

Embodiments of the present disclosure include calculating an operating extension readiness metric 522 with calculator 222 of computer system 202. Operating extension readiness metric 522 can include mathematical or descriptive models for indicating whether machine 450 is able to operate beyond its current operating duration, and/or the economic or technical benefits of extended operation. As examples, operating extension readiness metric 522 can include an economic benefit, an economic risk, a likelihood of failure (for machine 450 and/or the entire machine system 440), an engineering benefit, a recommended action, a readiness for extending machine 450 as compared to other machines 450 in the same machine system 440, etc. Extension readiness metrics can be based partially or completely on data 300 obtained in processes according to the present disclosure.

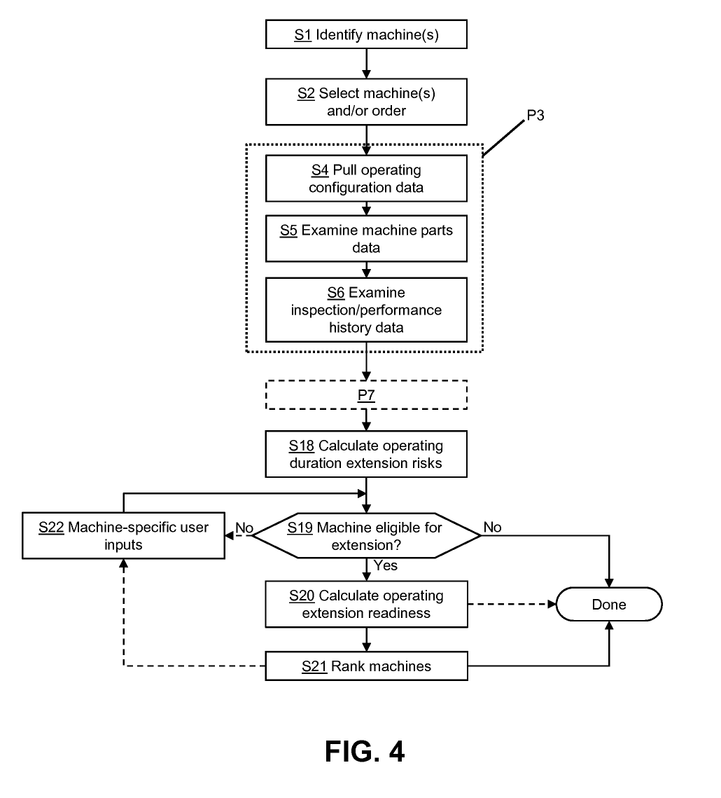

FIG. 4 provides an illustrative flow diagram of a method according to an embodiment of the present disclosure. Referring to FIG. 2 and FIG. 4 together, a user of computer system 202 can identify one or more machines 450 within machine system 440 in step S1. The identified machines 450 can include machines 450 which potentially have significant economic and/or technical benefits to operating beyond the current operating duration, a random group of machines, a group of related or similar-purpose machines, and/or machines chosen with any desired technique for selecting machines from within machine system 440. Machines 450 can be identified as candidates for examination and/or an extended operating duration by modules of operating duration program 218, e.g., determinator 220. Machines 450 can also be identified based on any desired factor such as a particular region, site, customer, or projected operating time span. In step S2, determinator 220 of computer system 202 can select one or more machines 450 identified in step S1 and/or an order for evaluating each machine 450. The machine(s) 450 selected in step S2 and/or the order in which each machine 450 is evaluated can be random, or may be derived from economic conditions, engineering conditions and/or requirements, or other data stored in memory 212. In a particular example, the identified machines 450 can be chosen based on having the greatest engineering and/or economic importance out of each machine 450 within machine system 440.

Embodiments of the present disclosure can include one or more steps for examining operating data for machine 450, which are grouped together as a process P3 in FIG. 4 for clarity and convenience. It is understood that the steps of process P3 can be performed in any desired order and that some steps can be omitted where desired. The examined data can be provided in any form usable with an embodiment of machine system manager 206 and/or operating duration program 218, including but not limited to variables and/or statistics for use in formulas and algorithms, descriptive and/or summary data for use in lookup tables, and other types of data for characterizing machine 450.

Examining operating data for machine 450 can include determinator 220 pulling operating configuration data in step S4. Operating configuration data can include any and all data 300 related to the intended use, design specifications, and engineering demands of machine 450. Other types of operating configuration data can include the load profile, firing temperature, steam or water injection, type of fuel used, etc. for each machine 450. Unit configuration inputs in step S4 can include without limitation, planned outage schedule input 502 (FIG. 3), contract modeling key inputs 504 (FIG. 3), configuration inputs 506 (FIG. 3), lifespan limits 514 (FIG. 3) of machine 450, operating profile inputs 516 (FIG. 3), and/or operability inputs 518 (FIG. 3). Operating configuration data can indicate the demands on machine 450 for the entirety of an operating duration or cycle, and therefore can describe whether machine 450 is capable of meeting the demands of its operating configuration beyond the current operating duration. Operating configuration data can also serve, in part, as the basis for determining future performance data and machine extension risks as discussed herein.

Examining operating data for machine 450 can include examining machine parts data in step S5. Machine parts data can include any and all data 300 related to parts, assemblies, subsystems, subassemblies, etc., within a particular machine 450. In an embodiment, machine parts data can be analogous to operating configuration data examined in step S4 for a particular part, rather than the entire machine 450. For example, each part may include data corresponding to its load profile, firing temperature, steam or water injection, type of fuel used, etc. Machine parts data examined in step S5 can include without limitation, part inputs 508 (FIG. 3), lifespan limits 514 (FIG. 3), and the unit configuration inputs described with respect to step S4 as applied to parts of machine 450. This data may have been obtained, e.g., by an onsite inspection performed by an inspector or a machine and stored as data within memory 212, machine system database 400, and/or machine 450. The condition and status of machine parts described as machine parts data can affect the ability for machine 450 to operate beyond its current operating duration, depending on particular parts and subsystems remain intact, and/or the availability of replacements.

Operating data can also include the inspection and performance history data of machine 450, which can be examined in step S6 as shown in FIG. 4. Inspection and performance history data of machine 450 can be obtained from any corresponding source stored within machine 450 and/or computer system 202, and for example can include inspection reports, inspection data, diagnoses, etc. stored as data. Inspection and performance history data can include any and all data 300 related to the past performance of machine 450 and the results of any previous inspections. Inspection and performance history data can include without limitation, inspection inputs 510 (FIG. 3), operating profile inputs 516 (FIG. 3), and/or operability inputs 518 (FIG. 3). Inspection and performance history data can describe the previous operation or current state of machine 450, which may affect the ability for machine 450 to operate beyond its current operating duration. The inspection and performance history data examined in step S6 can also indicate whether unexpected situations, disasters, etc. impair the condition of any machines 450.

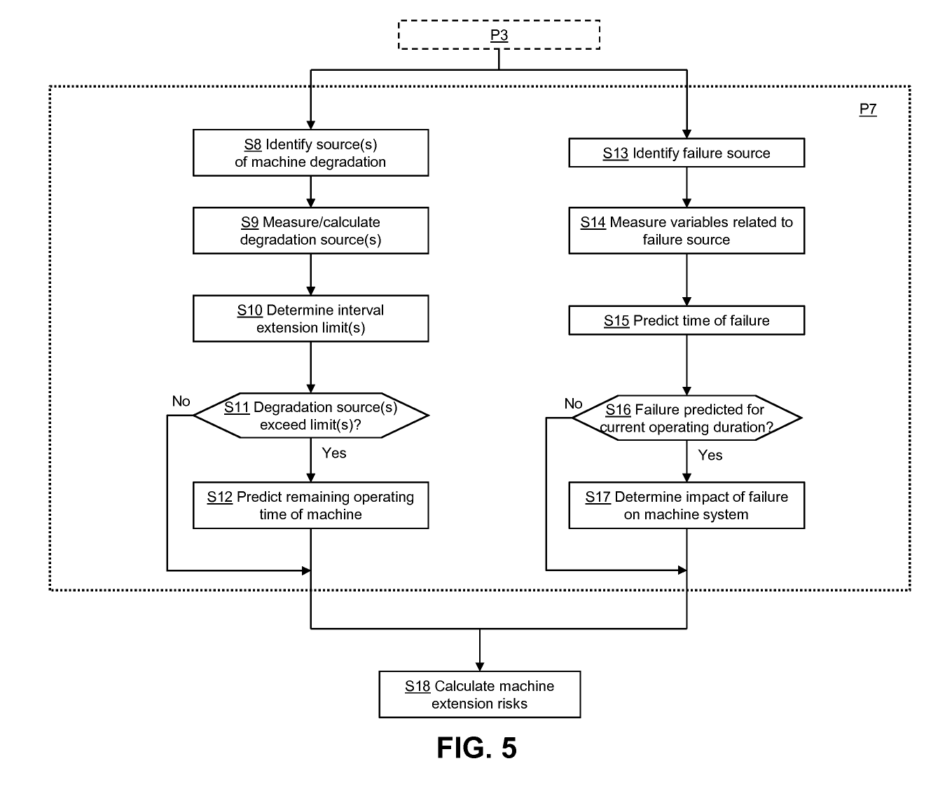

Embodiments of the present disclosure can include modeling future performance data for machine(s) 450, either for the remainder of the current operating duration or beyond the current operating duration, in process P7. Process P7 can include several steps, examples of which are shown in FIG. 5 for the purposes of illustration.

Referring to FIGS. 2 and 5 together, steps for modeling the future performance data of machine 450 in process P7 are shown. The branching steps shown in FIG. 5 can be performed alternatively, sequentially, or in parallel as desired. In step S8, determinator 220 can examine data 300 (which may include operating data obtained in the steps of P3) to identify one or more sources of degradation within machine 450. Sources of machine degradation can include, e.g., parts wearing down from continued use, system demands on machine 450 and/or corresponding machines exceeding their predicted values, impact of external variables or system disasters, etc. Methods of the present disclosure can also include measuring with sensor 452 and/or calculating variables with calculator 222 which quantify and/or describe the identified source(s) of degradation in step S9.

In step S10, determinator 220 can determine interval extension limits for machine 450. The interval extension limits for determine in step S10 can include, e.g., data 300 stored in memory 212 which indicate maximum and/or minimum values for a degradation source, or whether a particular degradation source increases the risk of machine 450 failing if permitted to operate beyond the current operating duration.

In step S11, determinator 220 can determine whether degradation sources exceed one or more limits for machine 450 or any of its parts. In the event that the degradation source is within tolerable limits, operating duration program 218 can mark machine 450 and or a part therein as being eligible to operate beyond its expected operating duration. This eligibility can be incorporated into extension readiness metric 522 (FIG. 3) as one factor in favor of extending the operating duration of machine 450. In cases where the degradation source exceeds acceptable limits, calculator 222 can predict whether machine 450 will fail within the current operating duration in step S12. Where machine 450 or a part therein is predicted to fail within the current operating interval, determinator 220 of operating duration program 218 can mark machine 450 as less eligible or even ineligible for an operating duration extension. Whether the identified degradation source(s) have exceeded their limits, the remaining operating time of machine 450 can be stored as future performance data 304 for machine 450. Thus, future performance data 304 can include, without limitation, contract modeling key inputs 504 (FIG. 3), configuration inputs 506 (FIG. 3), installed/inventory part details 508 (FIG. 3), lifespan limits 514 (FIG. 3), and/or other types of data 300 which can be derived from these data attributes, such as the remaining operating time of machine 450 before failure.

In addition or alternatively, methods of the present disclosure can include determinator 220 identifying a “failure source” for machine 450 in step S13. Specifically, steps S13-S17, shown in FIG. 5 and discussed herein, may apply where conditions within one or more machines 450 or parts thereof, of machine system 440 will likely fail. The machine subject to failure need not be the particular machine 450 under examination, as the failure of other machines 450 may affect interdependent machines 450 within the same machine system 440. A “failure source” can refer to any condition (random or cumulative) that may cause machine 450 or a particular part, subsystem, etc., to fail. Failure sources can include, e.g., failure of one or more parts, damage from internal and/or external factors, manufacturing errors, etc. Methods of the present disclosure can also include measuring with sensor 452 and/or calculating with calculator 222 representative variables for machine 450 related to the identified failure source in step S14. In addition, determinator 220 can also review the identified failure sources to determine whether any potential sources of failure have not been identified or evaluated before proceeding to further steps.

In step S15, calculator 222 can predict a time at which the identified failure source will cause machine 450 to fail. Inspections of each machine 450 or other analyses performed with sensor(s) 452 can identify whether the identified failure source has occurred. In addition to predicting a time of failure based on the identified failure source, determinator 220 can determine whether the predicted failure will occur within the current operating duration of machine 450. In step 516, determinator 220 can determine whether machine 450 is predicted to fail during or after the current operating duration. Where the failure of machine 450 is predicted to occur during the current operating duration, the method can proceed to step S17 for determining the impact of the predicted failure of machine 450 on machine system 440. For example, the failure and/or unavailability of a particular machine 450 may increase the mechanical load of other machines 450 within the same machine system 440. Other machines 450 may wear down more quickly because of a particular machine failing. The failure of certain machines 450 may in some cases disable the entire machine system 440. To examine the system-level effect of failure in step S17, calculator 222 can communicate the overall effect on machine system 440 by use of formulas, algorithms, lookup tables, etc. One example method step for translating a particular failure source into a probability of system failure includes assigning a “risk priority number” or relative importance to each identified failure source. The “risk priority number” can be set in response to several user estimations, such as severity, occurrences, detectability, etc. Failure sources with higher “risk priority numbers” are more likely to cause system-level failures in machine system 440, and calculator 222 can incorporate metrics such as a “risk priority number” into its calculations to determine whether machine system 440 will fail.

Following some or all of the steps described for process P7 of modeling future performance data, the method can continue to step S18 for calculating machine extension risks, which may be stored in memory 212 as operating duration extension risk data 306. Returning to FIGS. 2 and 4, calculator 222 in step S18 can use operating data 302, future performance data 304, and/or readings from sensor(s) 452 to calculate operating duration extension risks. Operating duration extension risks calculated in step S18 can be in the form of any variable, statistic, etc. for describing the risk of damage to machine 450, machine system 440, and/or other items of interest (e.g., potential damage to users or facilities). Calculator 222 in step S18 can also compute several operating duration extension risks simultaneously, e.g., measuring and/or obtaining risk inputs 512 (FIG. 3). In an embodiment, calculating the operating duration extension risk can include calculating a maximum potential extension for the operating duration of machine 450. The maximum potential extension can be based in part on data 300 and/or inputs from a user. The operating duration extension risks can also include a risk associated with machine 450 being permitted to operate for all or part of the calculated maximum potential extension.

After examining operating data 302, modeling future performance data 304, and/or calculating operating duration extension risk data 306, determinator 220 of computer system 202 can determine whether machine 450 is eligible for an operating duration extension in step S19. The eligibility of machine 450 for an operating duration extension can be based on any of several requirements, e.g., one or more operating duration extension risks being below a threshold value, one or more variables within the operating data and/or modeled future performance data exceeding a minimum value, some combination of requirements for each type of data, etc. Determinator 220 can specify in step S19 whether the examined machine(s) 450 meet these requirements, and the method can return to selecting other machine(s) 450 in the event that the eligibility requirements are unsatisfied. In an example embodiment, the risk of failure can be quantified as a probability, and machines 450 may be eligible for an extended operation duration if their risk of failure is below a certain threshold. A user of methods according to the present disclosure can designate, e.g., probabilities of 10% or less as being a “low risk” of failure, probabilities of 10%-30% as being a “medium risk” of failure, and probabilities of 30% or more as being a “high risk” of failure.

The method can continue to step S20 for calculating an operating extension readiness metric with calculator 222 where one or more machines 450 are eligible for an operating duration extension. Operating extension readiness metric can describe the relative desirability and/or benefits of extending the operating duration of a particular machine 450. Some example operating extension readiness metrics can include a risk of failure, a net economic benefit, a net engineering benefit, long-term quality improvements to machine system 440, and/or a recommended operation duration extension time. Calculator 222 can calculate operating extension readiness metrics for each machine 450 under examination and deemed eligible for an operating duration extension in step S19. Operating extension readiness metrics can illustrate whether machine 450 can operate beyond its current operating duration, and/or the economic or technical benefits of extended operation. As discussed elsewhere herein, operating extension readiness metric 522 can include an economic benefit, an economic risk, a likelihood of failure (for machine 450 and/or the entire machine system 440), an engineering benefit, a recommended action, a readiness for extending machine 450 as compared to other machines 450 in the same machine system 440, etc. Extension readiness metrics calculated in step S20 can also be expressed in terms of the economic benefit of extended operation over a particular length of time, e.g., dollars gained per unit time of extended operation. In the event that determinator 220 determines that the identified machines 450 are not eligible for an operating duration extension in step S19, the method can terminate or continue to a step S22 for accepting machine-specific user inputs, described in detail elsewhere herein, which may cause some machines 450 to become eligible for an operating duration extension.

After calculating operating extension readiness metrics in step S20, computer system 202 can end the method and/or select new machines for examination in step S2, as shown by the corresponding phantom process flow lines. In addition, the method can proceed to an additional step S21 after a predetermined number of machines 450 within machine system 440 are examined. Prioritizor 226 of operating duration program 218 can rank each machine 450 based on the operating readiness extension metrics calculated in step S20. Prioritizor 226 can rank each machine 450 automatically by reference to machine or user-generated criteria for ranking each machine 450 based on their operating extension readiness metrics. For example, prioritizor 226 can rank each machine 450 based on which machines 450 would provide the lowest risk, greatest economic and/or technical benefits, etc. Prioritizor 226 can provide the ranked order of machines 450 to a user with I/O device 217. In any event, a user or other computer, machine, etc. can use the output of methods according to the present disclosure to submit a request for one or more machines 450 to operate for longer than their current operating duration. Therefore, a technical effect of the present disclosure is to determine which machines amongst several machines within a machine system are eligible to have their operating durations extended to last longer than a planned operating duration.

In some embodiments, computer system 202 can request machine-specific user in a step S22 after the method is complete. Specifically, the resulting operating extension readiness metrics, operating data, future performance data, and/or operating duration extension risks can be provided to a user (e.g., in a spreadsheet) through I/O device 217. The user can then adjust particular criteria or override certain types of data, e.g., by sending commands to computer system 202 through I/O device 217. These user inputs may be particular to one or more identified machines 450 and may affect whether some machines are eligible or ineligible for an operating duration extension. Where machine-specific user inputs are received from a user in step S22, computer system 202 can determine again in step S19 whether particular machines 450 are eligible for an operating duration extension without repeating steps S1-S18.

The various embodiments discussed herein can offer several technical and commercial advantages, some of which are discussed herein by way of example. Embodiments of the present disclosure can increase the efficiency of a machine system while decreasing the costs of running a machine system by automatically evaluating opportunities to extend the operating duration of one or more machines based on user-generated or machine-generated criteria. The automatic evaluation of each machine can also filter out ineligible machines without review from a human user. Data indicating whether particular machines are eligible for an extended operating duration can also be provided directly to an engineering team by encoding the relevant information as data and transmitting the data over a network. The systems and methods described herein can also calculate and communicate the risks of allowing particular machines in a machine system to remain operational after delaying a scheduled time for performing inspections, repairs, and/or replacements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

As used herein, the term “configured,” “configured to” and/or “configured for” can refer to specific-purpose features of the component so described. For example, a system or device configured to perform a function can include a computer system or computing device programmed or otherwise modified to perform that specific function. In other cases, program code stored on a computer-readable medium (e.g., storage medium), can be configured to cause at least one computing device to perform functions when that program code is executed on that computing device. In these cases, the arrangement of the program code triggers specific functions in the computing device upon execution. In other examples, a device configured to interact with and/or act upon other components can be specifically shaped and/or designed to effectively interact with and/or act upon those components. In some such circumstances, the device is configured to interact with another component because at least a portion of its shape complements at least a portion of the shape of that other component. In some circumstances, at least a portion of the device is sized to interact with at least a portion of that other component. The physical relationship (e.g., complementary, size-coincident, etc.) between the device and the other component can aid in performing a function, for example, displacement of one or more of the device or other component, engagement of one or more of the device or other component, etc.

This written description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
a computing device in communication with a machine amongst a plurality of machines within a machine system, the machine being subject to a particular operating duration, wherein the computing device is configured to perform actions including:
examining operating data for the machine;
modeling future performance data for the machine;
calculating an operating duration extension risk for the machine;
determining whether the machine is eligible for an operating duration extension based on the examined operating data, the modeled future performance data, and the calculated operating duration extension risk; and calculating an extension readiness metric for the machine in response to the machine being eligible for the operating duration extension.

2. The system of claim 1, wherein the operating data for the machine includes at least one of operating purpose data, machine parts data, operating duration history data, and performance history data.

3. The system of claim 1, wherein the modeling of the future performance data for the machine further includes:
calculating a predicted time until failure of the machine;
comparing the predicted time until failure of the machine with a maximum operating duration extension; and
predicting a remaining operating time for the machine for a future operating duration in response to the maximum operating duration extension exceeding the predicted time until failure.

4. The system of claim 1, wherein the modeling of the future performance data for the machine further includes:
measuring a degradation variable for the machine;
predicting a time of failure based on the measured degradation variable; and
determining, in response to the predicted time of failure being within the operating duration of the machine, whether a failure of the machine will cause a failure of the machine system.

5. The system of claim 1, wherein the machine includes one of a turbine assembly and a turbine subassembly.

6. The system of claim 1, wherein the calculating of the operating duration extension risk includes calculating a maximum potential extension of the operating duration.

7. The system of claim 1, wherein the examining of the operating data includes determining a lifespan-limiting part within the machine.

8. The system of claim 1, wherein the computing device is further configured to calculate the operating extension readiness metric for the plurality of machines within the machine system, and rank the plurality of machines based on their respective operating extension readiness metrics.

9. The system of claim 1, wherein the operating extension readiness metric includes at least one of a failure risk, an economic benefit, and a recommended operating extension time.

10. A method implemented with a computing device, the method comprising:
examining operating data for a machine amongst a plurality of machines within a machine system with a determinator component of the computing device, the machine being subject to a particular operating duration;
modeling the future performance data for the machine with a calculator component of the computing device;
calculating an operating duration extension risk for the operating duration with the calculator component of the computing device;
determining whether the machine is eligible for an operating duration extension based on the examined operating data with the determinator component of the computing device, the modeled future performance data, and the calculated operating duration extension risk; and
calculating an operating extension readiness metric for the machine with the calculator component of the computing device in response to the machine being eligible for the operating duration extension.

11. The method of claim 10, wherein the operating data for the machine includes at least one of operating purpose data, machine parts data, operating duration history data, and performance history data.

12. The method of claim 10, wherein the modeling of the future performance data for the machine further includes:
calculating a predicted time until failure with the calculator component of the computing device;
comparing the predicted time until failure with a maximum operating duration extension with a comparator component of the computing device; and
predicting a remaining operating time for the machine within a future operating duration with the calculator component of the computing device in response to the maximum operating duration extension exceeding the predicted time until failure.

13. The method of claim 10, wherein the modeling of the future performance data for the machine further includes: measuring a degradation variable for the machine with the determinator component of the computing device; predicting a time of failure based on the measured degradation variable with the calculator component of the computing device; and
determining whether a failure of the machine will cause a failure of the machine system with the determinator component of the computing device in response to the predicted time of failure being within the operating duration of the machine.

14. The method of claim 10, wherein the machine includes one of a turbine assembly and a turbine subassembly.

15. The method of claim 10, wherein the calculating of the machine extension risk includes calculating a maximum potential extension of the operating duration.

16. The method of claim 10, the examining of operating data with the determinator component of the computing device includes determining a lifespan-limiting part within the machine.

17. The method of claim 10, further comprising calculating the operating extension readiness metric for the plurality of machines within the machine system with the calculator component of the computing device, and ranking the plurality of machines based on their respective operating extension readiness metrics with a prioritizor component of the computing device.

18. The method of claim 10, wherein the operating extension readiness metric includes at least one of a failure risk, an economic benefit, and a recommended operating extension time.

19. A program product stored on a computer readable storage medium for evaluating operating extension opportunities, the computer readable storage medium comprising program code for causing a computer system to:
examine operating data for a machine, the machine being subject to an operating duration, wherein the machine is one of a plurality of machines within a machine system;
model future performance data for the machine;
calculate an operating duration extension risk for the operating duration;
determine whether the machine is eligible for an operating duration extension based on the examined operating data, the modeled future performance data, and the calculated operating duration extension risk; and calculate an operating extension readiness metric for the machine in response to the machine being eligible for the operating duration extension.

20. The program product of claim 19, further comprising program code for causing the computer system to calculate the operating extension readiness metric for each of the plurality of machines within the machine system, and rank the plurality of machines within the machine system based on their respective operating extension readiness metrics.
